(19) United States
(12) Patent Application Publication
(10) Pub. No.: US 2025/0029401 A1
(43) Pub. Date: Jan. 23, 2025

(54) IMAGE PROCESSING DEVICE

(71) Applicant: Hitachi Astemo, Ltd., Hitachinaka-shi, Ibaraki (JP)

(72) Inventors: Felipe GOMEZCABALLERO, Chiyoda-ku, Tokyo (JP); Haruki MATONO, Chiyoda-ku, Tokyo (JP); Takeshi NAGASAKI, Hitachinaka-shi, Ibaraki (JP)

(73) Assignee: Hitachi Astemo, Ltd., Hitachinaka-shi, Ibaraki (JP)

(21) Appl. No.: 18/709,662

(22) PCT Filed: Nov. 4, 2022
(86) PCT No.: PCT/JP2022/041178

§ 371 Date: May 13, 2024

(30) Foreign Application Priority Data
Nov. 22, 2021 (JP) 2021-189408

(51) Int. Cl. G06V 20/56; G06T 7/20; G06T 7/593; G06T 7/70; G06V 20/58; G06V 20/64

(52) U.S. Cl. CPC G06V 20/588; G06T 7/20; G06T 7/593; G06T 7/70; G06V 20/58; G06V 20/64; G06T 2207/10012; G06T 2207/30244; G06T 2207/30261

(57) ABSTRACT

Provided is an image processing device that is capable of storing three-dimensional information relating to a road surface (3D road surface information), transforming/converting the stored 3D road surface information into a current time by using motion of a vehicle, using the three-dimensional information from the road surface together with monocular-based distance estimation processing, increasing the distance measurement accuracy without requiring a special sensor while maintaining the obstacle detection accuracy, and, in particular, supporting a case where an ego vehicle is turning at an intersection that may include a sidewalk area (that is, which includes a difference in ground height relative to a roadway area) that requires accurate monocular-based distance measurement for a detected obstacle. The obstacle ranging unit 161 performs monocular-based distance estimation processing, and uses the 3D road surface information stored via the 3D road surface information acquisition unit 131 and converted to the current time by the 3D road surface information management unit 141.

### TECHNICAL FIELD

The present invention relates to a vehicle-mounted image processing device for image-based obstacle detection and recognition in an environment near an ego vehicle, for example.

### BACKGROUND ART

In recent years, object detection devices that use images have been used to detect neighboring moving objects and obstacles. The aforementioned image-based object detection devices can be used in applications such as monitoring systems for detecting intrusions or anomalies, or vehicle-mounted systems for supporting safe driving of automobiles.

In vehicle-mounted applications, such devices are configured to display the surrounding environment to the driver and/or detect moving or static objects (obstacles) around the vehicle, notify the driver of a potential risk of a collision between the ego vehicle and an obstacle, and, on the basis of a determination system, automatically stop the vehicle to avoid a collision between the ego vehicle and the obstacle.

Incidentally, types of camera that serve as sensors for monitoring the surroundings of a vehicle include a monocular camera, and a stereo camera that uses a plurality of cameras. A stereo camera is capable of measuring the distance to a photographed object by utilizing the parallax of an overlapping region (also referred to as a stereo region) which is commonly photographed by two cameras at a predetermined interval. Therefore, it is possible to accurately grasp the possibility of collision with surrounding objects. Meanwhile, in a non-overlapping region (also referred to as a monocular region) photographed by each camera alone (monocular camera), it is difficult to grasp the distance to the photographed object (a moving object such as a pedestrian) only by detecting the object, and it is thus difficult to grasp the probability of collision. Therefore, methods for estimating the distance to a moving object detected in a monocular region include a method in which road-surface height information, which is measured in a stereo region, is also applied to the road surface in the monocular region.

However, in the case of the above-described conventional method, because the road surface height in the stereo region is applied without further processing to the monocular region, it is assumed that the road surface height in the stereo region and the road surface height in the monocular region are equal to each other, that is, that the road surface is a flat road surface. Therefore, when the road surface is stepped or inclined in the monocular region (in other words, when a pedestrian detected in the monocular region is not at the same height as the surface of the road being traveled), estimating an accurate distance is difficult.

For example, in view of the foregoing problem, the device disclosed in PTL 1 fulfills the purpose of performing a highly accurate calculation of the distance of a moving object detected in a monocular region, even in a case where the respective heights of the road surface in an overlapping region and in the monocular region are different from each other, the device including: a parallax information acquisition unit that acquires parallax information of an overlapping region of a plurality of images photographed by a plurality of cameras mounted on a vehicle; and an object distance calculation unit that calculates, on the basis of parallax information acquired in the overlapping region in the past, a distance between an object detected in a non-overlapping region other than the overlapping region in each of the images, and the vehicle.

### CITATION LIST

### Patent Literature

PTL 1: JP 2017-96777 A

### SUMMARY OF INVENTION

### Technical Problem

The device disclosed in PTL 1 above stores height information of a sidewalk road surface calculated on the basis of parallax information acquired in the overlapping region in the past, and, when an image region in which the height of a sidewalk road surface is measured moves to the non-overlapping region according to the movement of the vehicle, calculates the distance between the object and the vehicle by using the stored height information of the sidewalk road surface to correct the position of the object in an image height direction. That is, the device disclosed in PTL 1 above is based on the premise that, when an image region in which the height of the sidewalk road surface is measured moves to the non-overlapping region in accordance with the movement of the vehicle, the image region in which the height of the sidewalk road surface is measured is tracked from the overlapping region to the non-overlapping region in accordance with the movement of the vehicle.

Basic ego vehicle driving scenes include straight travel and turning. In a scene where the ego vehicle is traveling straight, the image region of the overlapping region moves to the non-overlapping region according to the movement of the vehicle, and the image region can be tracked from the overlapping region to the non-overlapping region according to the movement of the vehicle. Therefore, even in a case where the respective heights of the road surface in the overlapping region and the monocular region are different from each other, the technique disclosed in PTL 1 above can be applied to calculate the distance of a moving object detected in the monocular region.

Meanwhile, as a scene where an ego vehicle is turning at an intersection or the like, a scene may be considered where a moving object (pedestrian, bicycle, etc.) in a sidewalk area (that is, including a difference in ground height relative to a roadway area) suddenly appears (is photographed) in a monocular region. As an example, when the vehicle turns and starts crossing the intersection, a moving object hidden behind the object (outside the visual field of the camera) may appear in the monocular region. As another example, in a scene where the vehicle goes straight before turning, the moving object detected in the stereo region moves to the monocular region according to the movement of the vehicle, and then moves outside the monocular region (that is, it is out of the visual field of the camera). At this point in time, the moving object is located beside or beside and toward the rear of the ego vehicle, and cannot be tracked in the visual field of the camera. Thereafter, a case may be considered where, when the vehicle turns and starts to cross the intersection, the moving object that has been out of the visual field of the camera appears again in the monocular region (returns to the visual field of the camera) as the vehicle moves to perform the turn.

However, as described above, the device disclosed in PTL 1 is based on the premise that the image region of the overlapping area moves to the non-overlapping area according to the movement of the vehicle, and the image region is tracked from the overlapping area to the non-overlapping area according to the movement of the vehicle. Therefore, for example, in the case of a scene where the ego vehicle turns at an intersection that may include a sidewalk area, in a scene where a moving object in the sidewalk area suddenly appears in a monocular region (non-overlapping region), it is difficult to calculate an accurate distance for the moving object detected in the monocular region.

In addition, in general, in a scene where the ego vehicle is traveling straight, a change in the vehicle speed and a change in the current road surface conditions are considered to be relatively small, and thus the degree of impact of the change in the vehicle speed and the current road surface conditions on the spatial relationship between the road surface and a vehicle-mounted camera in which a change is generated in an initially set sensor attitude parameter (camera attitude parameter) is considered to be small.

Meanwhile, for example, in a scene where the ego vehicle is turning at an intersection or the like, because a change in the vehicle speed and a change in the current road surface conditions are considered to be relatively large, and thus, in response to the turning movement of the ego vehicle, the degree of impact of the change in the vehicle speed and the current road surface conditions on the spatial relationship between the road surface and a vehicle-mounted camera in which a change is generated in an initially set sensor attitude parameter (camera attitude parameter) is considered to be large.

However, the device disclosed in PTL 1 does not take into account the impact of a change in vehicle speed or of the current road surface conditions on the spatial relationship between the road surface and a vehicle-mounted camera in which a change is generated in an initially set sensor attitude parameter (camera attitude parameter). Therefore, also in this respect, in a scene where the ego vehicle is turning at an intersection that may include a sidewalk area, for example, it may not be possible to calculate an accurate distance of a moving object detected in the monocular region.

Thus, for example, when the ego vehicle is turning at an intersection that may include a sidewalk area (that is, which includes a difference in ground height relative to the roadway area), and at the same time, when the change in vehicle speed and the current road surface conditions affect the spatial relationship between the road surface and a vehicle-mounted sensor in which a change in an initially set sensor attitude parameter is generated, in a case where the system is used in a scene where there is a need to support accurate monocular-based distance measurement for the detected obstacle, the system may need an additional sensor to correctly set the sensor attitude parameter and accurately define the point where a target obstacle comes into contact with the road surface (which may change depending on the road surface shape and sidewalk type), thereby increasing the cost of the overall system. Meanwhile, in a case where external changes associated with sensor attitude changes and possible changes in the road surface shape (caused by sidewalks and other changes in height from the road surface on which the vehicle is passing) are not supported and not correctly addressed, then the obstacle detection performance and distance measurement accuracy may be reduced, thereby generating false obstacle detection results and reducing the reliability of the overall system.

An object of the present invention is to provide an image processing device that is capable of storing three-dimensional information relating to a road surface (hereinafter, also referred to as 3D road surface information) (the information being generated from image data of a stereo region), transforming/converting the stored 3D road surface information into a current time by using motion of a vehicle (calculated, for example, over time using velocity and a yaw rate from CAN data), using the three-dimensional information from the road surface together with monocular-based distance estimation processing, increasing the distance measurement accuracy without requiring a special sensor while maintaining the obstacle detection accuracy, and, in particular, supporting a case where an ego vehicle is turning at an intersection that may include a sidewalk area (that is, which includes a difference in ground height relative to a roadway area) that requires accurate monocular-based distance measurement for a detected obstacle.

### Solution to Problem

In order to achieve the above object, an image processing device according to the present invention includes: a 3D road surface information detection unit that, on the basis of images obtained from a plurality of cameras mounted on a vehicle, detects 3D road surface information including a three-dimensional structure of a road surface; a storage unit that stores the 3D road surface information, which is acquired chronologically; a coordinate conversion unit that converts 3D road surface information which is based on a position of the vehicle and an orientation of the camera at a first time (t−1) into 3D road surface information which is based on the position of the vehicle and the orientation of the camera at a second time (t), on the basis of a movement amount of the vehicle between the first time and the second time (t), and an orientation of the camera at the second time (t); and a ranging unit that determines a distance to an object in a visual field region of one camera among the plurality of cameras on the basis of the converted 3D road surface information acquired at the first time (t−1) and the 3D road surface information acquired at the second time (t).

### Advantageous Effects of Invention

According to the present invention, when an ego vehicle is turning at an intersection that may include a sidewalk area where there may be a difference in ground height relative to a roadway area, it is possible to perform accurate monocular-based distance measurement for a detected object, and thus improve the reliability of the overall system.

Problems, configurations, advantageous effects, and the like other than those described above will be clarified by the descriptions of the embodiments hereinbelow.

### BRIEF DESCRIPTION OF DRAWINGS

FIG. 1 is a schematic configuration diagram of an image processing device according to a first embodiment of the present invention.

FIG. 2 is a scene in which it is necessary to measure the distance to a specific pedestrian on a sidewalk when a vehicle is approaching an intersection and the ego vehicle is turning at the intersection, where (a) is the oldest time (t−a) when the vehicle turns left at the intersection, (b) is the time (t−b) when the vehicle is turning left at the intersection, and (c) is the current time (t) when the vehicle is turning left at the intersection.

FIG. 3 is a flowchart illustrating processing executed by a 3D road surface information management unit 141 to store and update calculated 3D road surface information.

FIG. 4 is an explanatory view of the relationships in a three-dimensional space between an X-axis, a Y-axis, a Z-axis, a tilt angle (pitch angle), and a roll angle.

FIG. 5 is a flowchart illustrating processing executed by the 3D road surface information management unit 141 to store, update, and delete calculated 3D road surface information of the image processing device according to a second embodiment of the present invention.

FIG. 6 is a flowchart illustrating processing executed by the 3D road surface information management unit 141 to store, update, and delete calculated 3D road surface information of the image processing device according to a third embodiment of the present invention.

### DESCRIPTION OF EMBODIMENTS

Hereinafter, preferred embodiments of the image processing device of the present invention will be described with reference to the drawings.

### First Embodiment

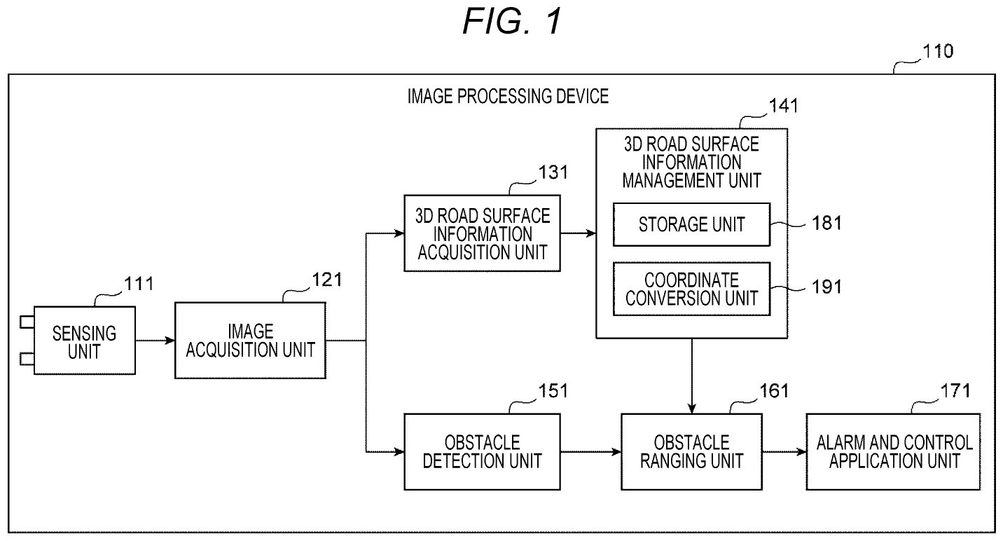

Hereinafter, the configuration and performance of the image processing device 110 according to the present embodiment will be described with reference to FIGS. 1 to 4. Although not illustrated, the image processing device 110 has a configuration in which a CPU, a RAM, a ROM, and the like are connected via a bus, and the CPU executes various control programs stored in the ROM to control the operation of the overall system.

It should be noted that, in the configuration described below, two camera sensors (hereinafter, may simply be referred to as cameras or sensors) are paired as a single vehicle-mounted stereo camera, and therefore correspond to the sensing unit 111. However, this configuration does not limit devices used in other configurations in which a single monocular camera is used as the sensing unit 111.

FIG. 1 is a block diagram illustrating a configuration of the image processing device according to the first embodiment of the present invention. The image processing device 110 according to the present embodiment is a device that is mounted, for example, on a vehicle (ego vehicle), executes image processing (for example, affine transformation) on a surrounding image photographed by a camera sensor (the sensing unit 111), detects and recognizes a surrounding object appearing in the image, and measures (calculates) the distance to the surrounding object.

In FIG. 1, the image processing device 110 includes a sensing unit 111 including two camera sensors arranged at the same height, an image acquisition unit 121, a 3D road surface information acquisition unit 131, a 3D road surface information management unit 141, an obstacle detection unit 151, an obstacle ranging unit 161, and an alarm and control application unit 171.

### (Image Acquisition Unit)

The image acquisition unit 121 processes images acquired by one or both camera sensors corresponding to the sensing unit 111, and adjusts image characteristics for further processing. This processing may include, but is not limited to, image resolution adjustments that make it possible to reduce or enlarge the input image and change the resulting image size, and image affine transformations such as image region-of-interest selection, rotation, scaling, shearing, and top surface image transformations where flat ground is regarded as a reference, which make it possible to crop (trim) a specific region of an input image from the original input for the sake of further processing. In the case of an affine transformation, a geometric formula or a transformation table can be calculated or adjusted in advance. The parameters used for image resolution adjustment and image region-of-interest selection can be controlled on the basis of the current driving environment and conditions (speed, turning speed, and the like). Further, stereo matching is performed using image signals received from both camera sensors corresponding to the sensing unit 111, and a three-dimensional distance image of a scene in front of the vehicle where the image processing device is mounted is created.

Stereo matching determines, for each predetermined unit region in two images to be compared with each other, a unit region in which the difference between image signals is minimized. That is, a region in which the same subject appears is detected. As a result, a three-dimensional distance image referred to below as a parallax image is formed. It should be noted that the parallax data is used to calculate the distance value from the camera to the object in an actual environment. Furthermore, a V-parallax image is created by projecting parallax data in a vertical direction onto a coordinate position V, acquiring parallax values in the horizontal axis direction, and integrating two-dimensional spaces that form a histogram image representing the frequency of each parallax value. That is, the V-parallax image is an image represented by the parallax values at the coordinate position V in the vertical direction and the coordinate position V in the horizontal direction.

In the case of a top surface image conversion, the image acquisition unit 121 also has a function for calculating a differential image representing a mismatch between at least two images which are acquired at different times by the sensing unit 111 and converted into the top surface image. A known method can be applied to calculate this differential. This calculation includes, but is not limited to, simple inter-pixel differential calculations and filter-based image differential calculations.

### (3D Road Surface Information Acquisition Unit)

The 3D road surface information acquisition unit 131 has a function for estimating three-dimensional surface characteristics/shapes (height, distance, inclination, etc.) of the road surface and the periphery thereof (sidewalk/step/road edge) on the basis of the parallax image created by the image acquisition unit 121. Here, the surface height refers to a height position of the surface/road surface with respect to a predefined plane, and refers to a height position estimated for each corresponding range in the depth direction with respect to the vehicle having the image processing device.

A processing example of surface characteristic estimation (in this case, the road surface height) is as follows.

First, a range (region) of the parallax image in which the road surface normally exists (in other words, becomes a road surface candidate) is set. Methods for setting a region may include the use of a pre-estimated road surface position, the use of a camera infinity point as a reference for region setting, the use of a defined parallax range as valid road surface data, the setting of a trapezoidal shape to define a road surface area, the use of detected lane markings to define a road surface shape, and so forth. The next step is to execute the extraction of a parallax value that is valid and included in a road surface candidate region. During data extraction, the available road surface parallax data is separated from the possible obstacle data. Methods for separating the road surface parallax data from the remaining parallax values include, but are not limited to, using pre-detected obstacle position data to estimate the position closest to the road surface, and comparing a predetermined threshold value and vertical parallax values to confirm that the parallax values gradually decrease in the vertical direction to the camera infinity point.

The next step is to project parallax data as road surface candidates onto a V-parallax space (coordinate positions V in a vertical direction and parallax values in the horizontal axis direction) to create a histogram image representing the frequencies of parallax values of the road surface candidates.

Thereafter, on the basis of the amount of data available in a predetermined range, a representative value can be selected for each parallax value in the vertical direction to reduce the amount of data describing the road surface.

The next step is to estimate a straight line (surface line) passing through the vicinity of pixels having a high histogram frequency in V-parallax representative data. It should be noted that the line estimated here may also be a curve, a set of straight lines, or a set of curves.

In the next step, the road surface line estimated in the previous step is received as an input, and the road surface height position is calculated.

### (3D Road Surface Information Management Unit)

The 3D road surface information management unit 141 has a function for storing (in memory), in the form of 3D road surface information, the three-dimensional surface characteristics/shapes estimated by the 3D road surface information acquisition unit 131.

According to the device configuration, the method for storing the 3D road surface information can be controlled by the amount of data stored in each processing cycle (for example, half of the range in the depth direction), the distance range of the stored 3D road surface information (for example, up to 25 m from the ego vehicle), and the interval at which the storage processing is executed (for example, when the ego vehicle speed is high, each 50 ms), on the basis of the device configuration and/or the current state of the ego vehicle on which the image processing device is mounted. Other methods/configurations for storing 3D road surface information data may also be implemented.

The 3D road surface information management unit 141 also has a function that uses the temporal motion (movement amount) of the vehicle and the camera attitude (orientation) at each time when the 3D road surface information is stored to convert (translate/rotate) the 3D road surface information stored in the previous period to the current time, and thus updates the 3D road surface information stored in the previous period to the current time. Thus, because the converted three-dimensional information relates to the position of the ego vehicle on which the image processing device is mounted, all the stored 3D road surface information can be used at the current time.

That is, the 3D road surface information management unit 141 includes a storage unit 181 that stores the 3D road surface information acquired chronologically by the 3D road surface information acquisition unit 131 (3D road surface information which is based on the position of the vehicle and the direction of the camera at the time of acquisition), and a coordinate conversion unit 191 that converts the 3D road surface information which is based on the position of the vehicle and the direction of the camera at the previous time into 3D road surface information which is based on the position of the vehicle and the direction of the camera at the current time, on the basis of the movement amount of the vehicle between the previous time and the current time and the direction of the camera at the current time (details will be described below).

### (Obstacle Detection Unit)

The obstacle detection unit 151 uses but is not limited to images created by the image acquisition unit 121 and uses a differential image to employ a known clustering method that takes into account the distance between points (pixels) (for example, the K-means algorithm), and has a function for detecting and calculating the position of a three-dimensional object in an image by using a method for creating a cluster of differential pixels that are close to each other and likely to represent a target obstacle on a road surface. Note that, in the present specification, “obstacle detection” refers to processing for executing at least the next task. Target object detection (position in image space), and target object identification (for example, an automobile/vehicle, a two-wheeled vehicle, a bicycle, a pedestrian, a pole, etc.).

### (Obstacle Ranging Unit)

The obstacle ranging unit 161 has a function for measuring the distance from an ego vehicle (on which the image processing device is mounted) to one or more of the obstacles detected by the obstacle detection unit 151 and acquiring the distance measurement value from the ego vehicle to the target object in a three-dimensional space that enables calculation of the velocity/speed of the target object by using, in combination, a monocular-based method that relies on geometric calculation using camera attitude parameters and a method using 3D road surface information (specifically, the converted 3D road surface information acquired at the previous time and the 3D road surface information acquired at the current time) managed by the 3D road surface information management unit 141. Usage examples include (but are not limited to) average distance measurements from the results of both methods, weighted averages of distance measurements from the results of both methods (the weights for the results of each method are predetermined or adjusted in real time on the basis of the amount of available 3D road surface information) (default weights are equal for each method), distance measurements using a monocular-based method with error rate calculations using 3D road surface information as an indicator of reliability, and distance measurements using a 3D road surface information method with error rate calculations using a monocular base as an indicator of reliability, and so forth.

Further, the methods described above can be used individually as needed depending on the device configuration and/or current system state (stop/give-up/error in processing associated with either method).

### (Alarm and Control Application Unit)

The alarm and control application unit 171 has a function for determining an alarm routine (an audible or visual alarm message to the driver) or a control application to be executed by the vehicle on which the image processing device is mounted, according to the obstacle recognized by the obstacle detection unit 151 and the result obtained by the obstacle ranging unit 161.

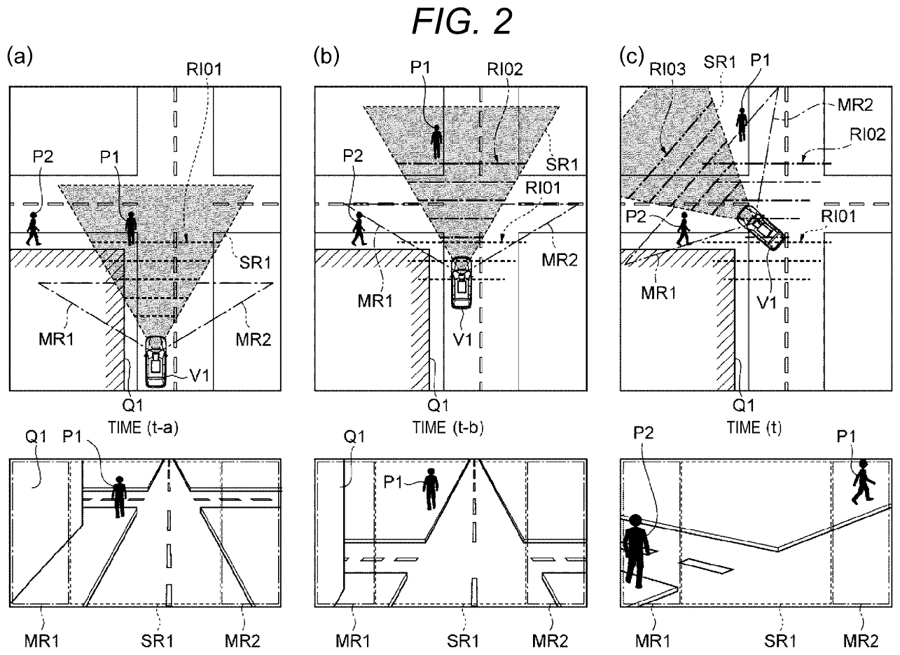

Here, a case where the image processing device 110 is applied as a system for monitoring the surroundings of the vehicle V1 will be described with reference to FIGS. 2(a), 2 (b), and 2(c). The upper parts of FIGS. 2(a), 2 (b), and 2(c) illustrate, in a top view, a scene in which a vehicle V1 is turning left at an intersection, and FIGS. 2(a), 2(b), and 2(c) illustrate the same vehicle V1 moving toward a left turn at the intersection in different periods. FIG. 2(a) illustrates the oldest time (t−a) at which the vehicle V1 turns left at the intersection, FIG. 2(c) illustrates the current time (t) at which the vehicle V1 turns left at the intersection, and FIG. 2(b) illustrates the time (t−b) between the time (t−a) and the time (t) at which the vehicle V1 turns left at the intersection. The lower parts of FIGS. 2(a), 2(b), and 2(c) illustrate the same scene as viewed from the image acquired by the image acquisition unit 121. The stereo region SR1 refers to a region where the image signals received from both camera sensors corresponding to the sensing unit 111 overlap, and thus can be used to calculate a parallax image and acquire the 3D road surface information calculated by the 3D road surface information acquisition unit 131. The monocular region MR1 and the monocular region MR2 refer to regions where the image signals received from both camera sensors corresponding to the sensing unit 111 do not overlap, and therefore only the monocular image that can be used for obstacle detection by the obstacle detection unit 151 is available.

For the period (t−a) illustrated in FIG. 2(a), vehicle V1 crosses forward toward the intersection, and at this point in time, pedestrian P1 on the sidewalk moves in the same direction as vehicle V1. At time (t−a), the 3D road surface information RI01 is acquired from the stereo region SR1 by the 3D road surface information acquisition unit 131 (the data of the pedestrian P1 is removed), and then stored by the 3D road surface information management unit 141 for further processing. At this point in time, the pedestrian P2 is hidden behind an object Q1 (exists outside the visual field of the camera and does not appear in the image).

For the period (t−b) illustrated in FIG. 2(b), the vehicle V1 is still crossing forward toward the intersection, and at this point in time the pedestrian P1 on the sidewalk is also still moving in the same direction as the vehicle V1. At time (t−b), the 3D road surface information RI02 is acquired from the stereo region SR1 by the 3D road surface information acquisition unit 131 (the data of the pedestrian P1 is removed), and is stored by the 3D road surface information management unit 141 for further processing. Next, the already stored 3D road surface information RI01 is converted (translated/rotated) to the current time (t−b) by using the motion (movement amount) of the vehicle from the time (t−a) to the time (t−b) and the camera attitude (orientation) at the time (t−a) and the time (t−b). After the 3D road surface information is updated, all the 3D road surface information stored by the image processing device should be in the same time and space as the 3D road surface information stored at time (t−b) and thus related to the position of the vehicle V1. At this point in time, the pedestrian P2 is also still hidden behind the object Q1 (present outside the visual field of the camera and not shown in the image).

For the period (t) illustrated in FIG. 2(c), the vehicle V1 turns left at the intersection, and at this point in time, the target pedestrian P2 on the sidewalk is detected by the obstacle detection unit 151 in the monocular region MR1, and the pedestrian P1 on the sidewalk continues to move away from the vehicle V1. At time (t), the 3D road surface information RI03 is acquired from the stereo region SR1 by the 3D road surface information acquisition unit 131, and is stored by the 3D road surface information management unit 141 for further processing. The already stored 3D road surface information RI01 and RI02 are then converted (translated/rotated) to the current time (t) by using the motion (movement amount) of the vehicle from time (t−b) to time (t) and the camera attitude (orientation) at time (t−b) and time (t). After the 3D road surface information is updated, all the 3D road surface information stored by the image processing device should be in the same time and space as the 3D road surface information stored at time (t) and thus related to the position of the vehicle V1. In the period (t), the stored 3D road surface information RI01, RI02, and RI03 are used by the obstacle ranging unit 161, and it is possible to acquire distance measurement values for the target pedestrian P2 (detected by the obstacle detection unit 151 in the monocular region MR1) together with a monocular-based method that relies on geometric calculation using camera attitude parameters. The reference position in the space of the 3D road surface information for the target pedestrian P2 can be calculated on the basis of the position associated with the vehicle V1 in the form of an angle from the center of the image processing device to the center of the target pedestrian P2, and the calculated position can then be used to access the corresponding distance data from the 3D road surface information. Thus, even in a case where there is a difference in ground height relative to the roadway area (road surface being traveled on), it is possible to achieve highly accurate distance measurement for the pedestrian P2 on the sidewalk.

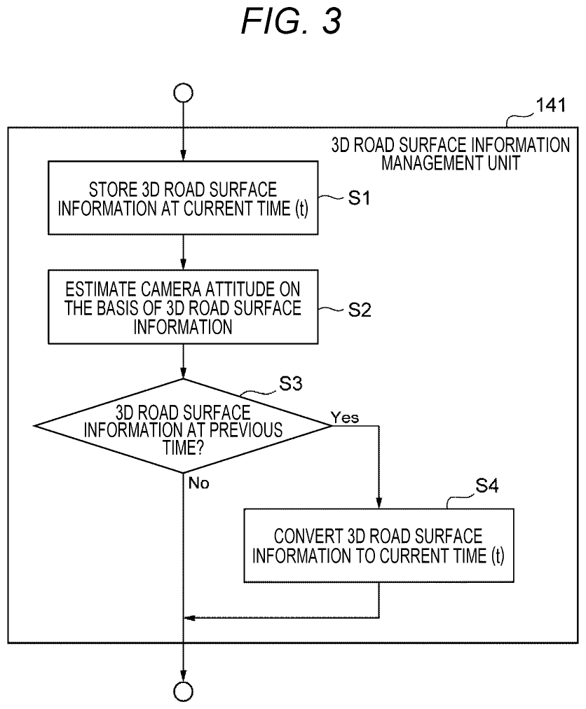

FIG. 3 is a flowchart illustrating exemplary processing executed by the 3D road surface information management unit 141 by using the output of the 3D road surface information acquisition unit 131. Note that the current time is denoted by (t), and the previous time is denoted by (t−n), where n is a numerical value from 1 to N.

First, in step S1 (step of storing the 3D road surface information at the current time (t)), the three-dimensional surface characteristic/shape corresponding to the current time (t) estimated by the 3D road surface information acquisition unit 131 is retrieved and stored (in the storage unit 181).

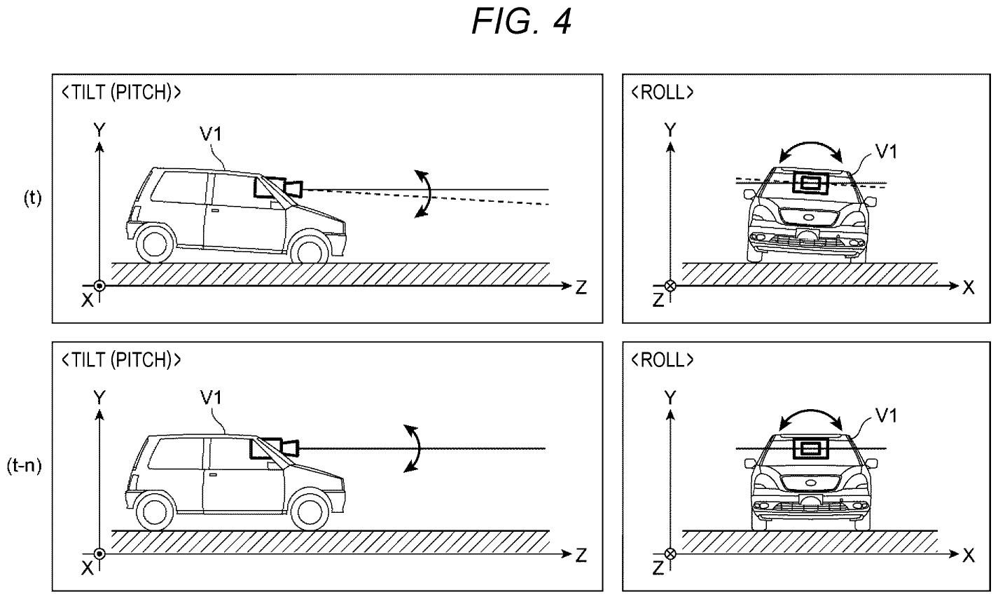

Next, step S2 (the step of estimating the camera attitude on the basis of 3D road surface information) estimates the camera attitude parameters on the basis of the stored three-dimensional surface characteristics/shapes corresponding to the current time (t), and stores and uses the results for further processing. As an example of camera attitude estimation, the inclination of the road surface in front of the vehicle V1 on the X axis and the Y axis can be calculated using a three-dimensional surface (although not limited thereto), and, as a result, the pitch angle (tilt angle) and the roll angle of the image processing device with respect to the three-dimensional surface in front of the vehicle V1 can be calculated using the road surface inclination thus obtained (see also FIG. 4).

Next, step S3 (step for checking for the presence of previous data) entails checking for the presence of 3D road surface information stored previously. In a case where there is no 3D road surface information other than information stored at the current time (t), no additional processing is required in this step. In a case where previous 3D road surface information is stored (for example, time (t−n)), the processing advances to step S4.

Next, step S4 (step for converting the 3D road surface information into the current time (t)) updates the 3D road surface information stored in the previous period to the current time (t).

This update can be performed (but is not limited to), in the form of an X-axis and Z-axis translation and Y-axis rotation (yaw angle) based on the use of vehicle motion (difference between the X-position and Z-position) (movement amount) occurring from a previous time (t−n) to the current time (t), applying affine transformations complemented by X-axis rotation (tilt angle) and Z-axis rotation (roll angle) based on the camera attitude parameters at the current time (t) (see also FIG. 4).

Finally, the processing is completed, and the processing moves to the obstacle ranging unit 161 for further processing.

By adopting the above processing, all the stored 3D road surface information can be used for distance measurement in relation to the position of the ego vehicle at the current time (t). Furthermore, because all the stored 3D road surface data are updated to the latest current time (t) at the end of this processing by the update processing, the conversion that occurs as a result in a future period does not need to go back to each period in which each piece of 3D road surface information is stored.

The configuration and operation of the image processing device according to the first embodiment have been described above. The image processing device according to the first embodiment makes it possible to perform accurate monocular-based distance measurement on a detected obstacle when the ego vehicle is turning at an intersection that may include a sidewalk area where there may be a difference in ground height relative to a roadway area (road surface being traveled on), thereby improving the reliability of the overall system.

### Second Embodiment

Next, an image processing device according to a second embodiment of the present invention will be described.

A basic configuration of the image processing device according to the second embodiment is different from the configuration of the first embodiment with respect to the following points.

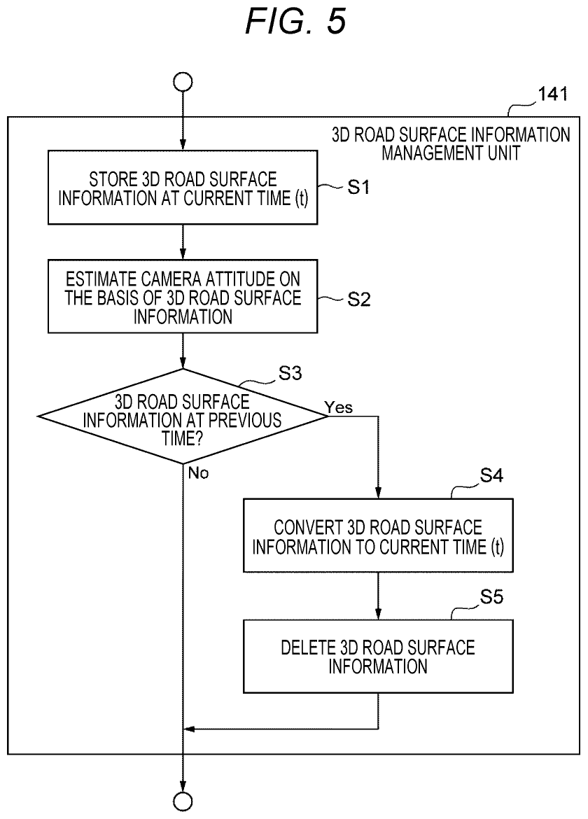

As disclosed in FIG. 5, the 3D road surface information management unit 141 according to the second embodiment has an additional function for deleting stored 3D road surface information.

3D road surface information deletion processing can be performed before or after the 3D road surface information update processing, but in the present example, as illustrated in the flowchart of FIG. 5, the deletion processing is performed after the update processing. In the flowchart of FIG. 5, step S5 (step of deleting the 3D road surface information) deletes the stored target 3D road surface information (from the storage unit 181) on the basis of the device configuration. Examples of such a configuration in which the 3D road surface information is to be deleted include (but are not limited to) 3D road surface information located at a specific distance behind the ego vehicle (for example, 30 meters behind the vehicle), and 3D road surface information stored at a specific time before (for example, five minutes before) the corresponding current time (t).

That is, (the coordinate conversion unit 191 of) the 3D road surface information management unit 141 according to the second embodiment deletes, among converted 3D road surface information (may be pre-converted 3D road surface information), 3D road surface information of a portion through which the vehicle has passed at the current point in time (corresponds to a specific distance before the position at the current time, a specific time before the current time, and the like) (step S5).

By adopting the above processing, it is possible to reduce the amount of memory required for the stored 3D road surface information in the image processing device while maintaining the same functional operation as in the first embodiment.

The configuration and operation of the image processing device according to the second embodiment have been described above. The image processing device according to the second embodiment makes it possible to perform accurate monocular-based distance measurement on a detected obstacle when the ego vehicle is turning at an intersection that may include a sidewalk area where there may be a difference in ground height relative to a roadway area (road surface being traveled on), thereby improving the reliability of the whole system, reducing an amount of memory required for stored 3D road surface information, and maintaining the same functional operation as in the first embodiment.

### Third Embodiment

Next, an image processing device according to a third embodiment of the present invention will be described.

A basic configuration of the image processing device according to the third embodiment is different from the configuration of the first embodiment with respect to the following points.

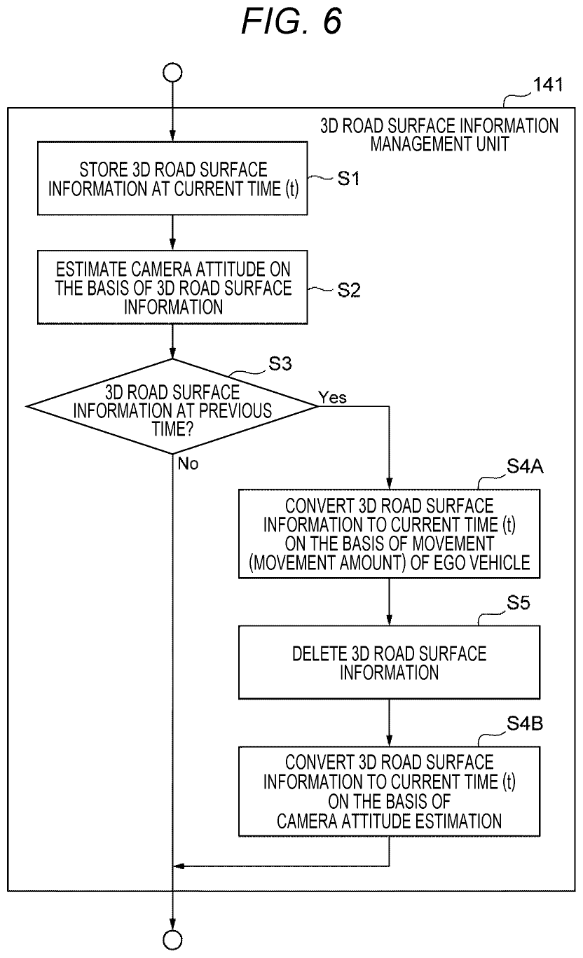

The 3D road surface information management unit 141 according to the third embodiment has an additional function for deleting stored 3D road surface information, and the 3D road surface information update processing is divided into two steps (S4A, S4B) as illustrated in FIG. 6.

Step S4A of the 3D road surface information update processing updates the 3D road surface information stored in the previous period to the current time (t) by applying affine transformation in the form of parallel movement of the X axis and the Z axis and rotation of the Y axis (yaw angle) based on usage of the motion (difference between the X position and the Z position) (movement amount) of the vehicle occurring from the previous time (t−n) to the current time (t) (although not limited thereto).

Step S4B of the 3D road surface information update processing updates the 3D road surface information stored in the previous period (remaining in the storage unit 181 after the deletion processing) to the current time (t) by applying affine transformation that complements the update executed in step S4A in the form of rotation (tilt angle) of the X axis and rotation (roll angle) of the Z axis based on the camera attitude parameter of the current time (t) (although not limited thereto).

As illustrated in the flowchart of FIG. 6, the 3D road surface information deletion processing is performed between step S4A of the 3D road surface information update processing and step S4B of the 3D road surface information update processing. In the flowchart of FIG. 6, step S5 (a step of deleting the 3D road surface information) deletes the stored target 3D road surface information (from the storage unit 181) on the basis of the device configuration. Examples of such a configuration in which the 3D road surface information is to be deleted include (but are not limited to) 3D road surface information located at a specific distance behind the ego vehicle (for example, 30 meters behind the vehicle), and 3D road surface information stored at a specific time before (for example, five minutes before) the corresponding current time (t).

That is, (the coordinate conversion unit 191 of) the 3D road surface information management unit 141 according to the third embodiment converts the 3D road surface information on the basis of the position of the vehicle at the previous time into the 3D road surface information which is based on the position of the vehicle at the current time, on the basis of the movement amount of the vehicle between the previous time (first time) and the current time (second time) (step S4A), deletes, among the converted 3D road surface information, 3D road surface information of a portion through which the vehicle has passed at the current point in time (corresponds to a specific distance before the position at the current time, a specific time before the current time, etc.) (step S5), and, on the basis of the orientation of the camera at the current time, performs correction of the coordinate space of the 3D road surface information on, among the converted 3D road surface information, 3D road surface information of a portion through which the vehicle has not passed at the current point in time (step S4B).

By adopting the above processing, it is possible to reduce the amount of memory required for the stored 3D road surface information in the image processing device and shorten the processing time required to update the 3D road surface information that remains stored in the memory while maintaining the same functional operation as that of the first embodiment.

The configuration and operation of the image processing device according to the third embodiment have been described above. The image processing device according to the third embodiment makes it possible to perform an accurate monocular-based distance measurement on a detected obstacle when an ego vehicle is turning at an intersection that may include a sidewalk area where there may be a difference in ground height relative to a roadway area (road surface being traveled on), thereby improving the reliability of the whole system, reducing the amount of memory required for stored 3D road surface information, reducing the processing time required to update 3D road surface information that remains stored in memory, and maintaining the same functional operation as that of the first embodiment.

As described above, the image processing device 110 for obstacle detection and obstacle recognition according to the present embodiment and illustrated in FIG. 1, for example, includes the following:
a sensing unit 111 including two sensing units (cameras) capable of capturing images of scenes in front of a device to which the device is attached;
an image acquisition unit 121 that processes an image acquired by the sensing unit 111, adjusts characteristics (including, but not limited to, image size, image resolution, and image region of interest) thereof, executes three-dimensional data generation for collating images acquired from both sensing units, and calculates the parallax of each of the pixels;
a 3D road surface information acquisition unit 131 that executes road surface shape estimation by using the parallax information calculated by image acquisition unit 121 and acquires road surface characteristics (height, distance, etc.) in each range in the depth direction;
a 3D road surface information management unit 141 that executes a function (storage unit 181) for storing the 3D road surface information calculated by the 3D road surface information acquisition unit 131, and executes a function (coordinate conversion unit 191) for updating the 3D road surface information by transforming/converting the previously stored 3D road surface information to the current time by using the motion (movement amount) of the vehicle as time elapses;
an obstacle detection unit 151 that executes object detection and object recognition by using images acquired by the image acquisition unit 121;
an obstacle ranging unit 161 which performs a monocular-based three-dimensional distance measurement from the ego vehicle to the obstacle detected by the obstacle detection unit 151 by using a combination of a geometric calculation using the camera attitude parameters and the use of the available 3D road surface information updated at the current time by the 3D road surface information management unit 141; and an alarm and control application unit 171 that determines an alarm routine or a control application to be executed by a device to which the device is attached, on the basis of current conditions that may include at least outputs from the obstacle detection unit 151 and the obstacle ranging unit 161.

That is, the image processing device 110 according to the present invention includes: a 3D road surface information detection unit (the 3D road surface information acquisition unit 131) that, on the basis of images obtained from a plurality of cameras mounted on a vehicle, detects 3D road surface information including a three-dimensional structure of a road surface; a storage unit 181 that stores the 3D road surface information, which is acquired chronologically; a coordinate conversion unit 191 that converts (translates/rotates) 3D road surface information which is based on a position of the vehicle and an orientation of the camera at a first time (t−1) into 3D road surface information which is based on the position of the vehicle and the orientation of the camera at a second time (t), on the basis of a movement amount of the vehicle between the first time and the second time (t) and an orientation (attitude: tilt angle, roll angle) of the camera at the second time (t); and a ranging unit (obstacle ranging unit 161) that determines a distance to an object in a visual field region (monocular region) of one camera among the plurality of cameras, on the basis of the converted 3D road surface information acquired at the first time (t−1) and the 3D road surface information acquired at the second time (t).

In addition, the coordinate conversion unit 191 converts 3D road surface information which is based on the position of the vehicle at the first time (t−1) into 3D road surface information which is based on the position of the vehicle at the second time (t), on the basis of the movement amount of the vehicle between the first time (t−1) and the second time (t), deletes, among the converted 3D road surface information, 3D road surface information of a portion through which the vehicle has passed at the second time (t), and, on the basis of the orientation of the camera at the second time (t), performs correction of the coordinate space of the 3D road surface information on, among the converted 3D road surface information, 3D road surface information of a portion through which the vehicle has not passed at the second time (t).

By adopting this configuration, it is possible, using the obstacle ranging unit 161 and without adding a dedicated sensor, to reliably execute distance measurement together with the monocular-based distance estimation processing by using the 3D road surface information which has been stored via the 3D road surface information acquisition unit 131 and converted to the current time by the 3D road surface information management unit 141, and it is thus possible to maintain the obstacle detection accuracy and add support for a case where the ego vehicle is turning at an intersection that may include a sidewalk area.

According to the embodiment, when an ego vehicle is turning at an intersection that may include a sidewalk area where there may be a difference in ground height relative to a roadway area, it is possible to perform accurate monocular-based distance measurement for a detected object, and thus improve the reliability of the overall system.

While preferred embodiments of the invention which are under consideration currently have been described, various changes may be made to the embodiments and all changes within the true spirit and scope of the present invention are intended to fall within the scope of the appended claims.

For example, in the above-described embodiment, a camera (a stereo camera using a plurality of cameras) is used as a sensor for monitoring the surroundings of the vehicle and detecting 3D road surface information including a three-dimensional structure of the road surface, but a sensor such as a millimeter wave radar or a laser radar may be used together with or instead of the camera. In other words, in the present embodiment, a monocular camera and a sensor such as a millimeter wave radar or a laser radar may be used in combination. Here, for example, the visual field region (range) of the monocular camera may be wide and may exceed the measurement region (range) of the sensor. That is, the image processing device 110 according to the present embodiment may include: a 3D road surface information detection unit that, on the basis of information obtained from a sensor mounted on a vehicle, detects 3D road surface information including a three-dimensional structure of a road surface; a storage unit that stores the 3D road surface information, which is acquired chronologically; a coordinate conversion unit that converts 3D road surface information which is based on a position of the vehicle and an orientation of the sensor at a first time (t−1) into 3D road surface information which is based on the position of the vehicle and the orientation of the sensor at a second time (t), on the basis of a movement amount of the vehicle between the first time and the second time (t), and an orientation of the sensor at the second time (t); and a ranging unit that determines a distance to an object in a visual field region of one camera mounted on the vehicle, on the basis of the converted 3D road surface information acquired at the first time (t−1) and the 3D road surface information acquired at the second time (t).

Furthermore, the present invention is not limited to or by the above-described embodiments, and includes various modifications. For example, the above-described embodiments have been described in detail to facilitate understanding of the present invention, and embodiments of the present invention are not necessarily limited to embodiments having all the described configurations.

Moreover, some or all of the above-described configurations, functions, processing units, and the like may be implemented by hardware, for example, by a design using an integrated circuit. In addition, each of the above-described configurations, functions, and the like may be implemented by software as a result of the processor interpreting and executing a program that implements the respective functions. Information such as a program, a table, and a file for implementing each function can be stored in a recording device such as a memory, a hard disk, or a solid state drive (SSD), or on a recording medium such as an IC card, an SD card, and a DVD.

Moreover, control lines and information lines that are considered necessary for the sake of the description are illustrated, and not all control lines and information lines are necessarily illustrated for a product. In practice, almost all the configurations may be considered to be connected to each other.

### REFERENCE SIGNS LIST

110 image processing device
111 sensing unit
121 image acquisition unit
131 3D road surface information acquisition unit (3D road
surface information detection unit)
141 3D road surface information management unit
151 obstacle detection unit
161 obstacle ranging unit (ranging unit)
171 alarm and control application unit
181 storage unit
191 coordinate conversion unit

1. An image processing device, comprising:
a 3D road surface information detection unit that, on a basis of images obtained from a plurality of cameras mounted on a vehicle, detects 3D road surface information including a three-dimensional structure of a road surface;
a storage unit that stores the 3D road surface information, which is acquired chronologically;
a coordinate conversion unit that converts 3D road surface information which is based on a position of the vehicle and an orientation of the camera at a first time (t−1) into 3D road surface information which is based on the position of the vehicle and the orientation of the camera at a second time (t), on a basis of a movement amount of the vehicle between the first time (t−1) and the second time (t), and an orientation of the camera at the second time (t); and
a ranging unit that determines a distance to an object in a visual field region of one camera among the plurality of cameras on a basis of the converted 3D road surface information acquired at the first time (t−1) and the 3D road surface information acquired at the second time (t).

2. The image processing device according to claim 1,
wherein the coordinate conversion unit converts 3D road surface information which is based on the position of the vehicle at the first time (t−1) into 3D road surface information which is based on the position of the vehicle at the second time (t), on a basis of the movement amount of the vehicle between the first time (t−1) and the second time (t), deletes, among the converted 3D road surface information, 3D road surface information of a portion through which the vehicle has passed at the second time (t), and, on a basis of the orientation of the camera at the second time (t), performs correction of the coordinate space of the 3D road surface information on, among the converted 3D road surface information, 3D road surface information of a portion through which the vehicle has not passed at the second time (t).

3. The image processing device according to claim 1, wherein the coordinate conversion unit deletes, among the converted 3D road surface information or the pre-conversion 3D road surface information, 3D road surface information of a portion through which the vehicle has passed at the second time (t).

4. The image processing device according to claim 1, wherein the ranging unit determines the distance to the object on a basis of the converted 3D road surface information acquired at the first time (t−1), the 3D road surface information acquired at the second time (t), and a position detection result on the image of an object in the visual field of one camera among the plurality of cameras.

5. An image processing device, comprising:
a 3D road surface information detection unit that, on a basis of information obtained from a sensor mounted on a vehicle, detects 3D road surface information including a three-dimensional structure of a road surface;
a storage unit that stores the 3D road surface information, which is acquired chronologically;
a coordinate conversion unit that converts 3D road surface information which is based on a position of the vehicle and an orientation of the sensor at a first time (t−1) into 3D road surface information which is based on the position of the vehicle and the orientation of the sensor at a second time (t), on a basis of a movement amount of the vehicle between the first time (t−1) and the second time (t), and an orientation of the sensor at the second time (t); and
a ranging unit that determines a distance to an object in a visual field region of one camera mounted on the vehicle, on a basis of the converted 3D road surface information acquired at the first time (t−1) and the 3D road surface information acquired at the second time (t).
